(19) United States
(12) Patent Application Publication
(10) Pub. No.: US 2013/0109229 A1
(43) Pub. Date: May 2, 2013

(54) COAXIAL CONNECTOR

(71) Applicant: Michael Jospeh Vino, IV, Landisville, PA (US)

(72) Inventor: Michael Jospeh Vino, IV, Landisville, PA (US)

(73) Assignee: TYCO ELECTRONICS CORPORATION, BERWYN, PA (US)

(21) Appl. No.: 13/287,505

(22) Filed: Nov. 2, 2011

(51) Int. Cl. H01R 9/05

(52) U.S. Cl. 439/578

(57) ABSTRACT

A coaxial connector is provided for mating with a mating connector. The coaxial connector includes a dielectric insert, an inner electrical contact held by the dielectric insert, and a housing including a dielectric body and an electrically conductive sleeve mounted to the dielectric body. The electrically conductive sleeve includes a receptacle. The dielectric insert is held within the receptacle of the electrically conductive sleeve. The electrically conductive sleeve includes an outer electrical contact that extends around and is concentrically aligned with the inner electrical contact. The electrically conductive sleeve has a thread for threadably connecting the coaxial connector to the mating connector.

### BACKGROUND OF THE INVENTION

The subject matter described and/or illustrated herein relates generally to coaxial connectors.

Coaxial connector assemblies are used with and employed in a wide variety of electronic devices and packages. Coaxial connector assemblies include two complementary coaxial connectors, such as a plug and a jack, that mate together to establish an electrical connection between electrical components. Coaxial connectors typically include a housing that holds an inner electrical contact. The housing may also hold an outer electrical contact that is concentrically aligned with the inner electrical contact. Alternatively, a portion of the housing forms the outer electrical contact of the coaxial connector. The housings of complementary coaxial connectors are sometimes threadably connected together to hold mated complementary coaxial connectors together.

The housings of at least some known coaxial connectors are fabricated using a screw machine process wherein the housing is machined out of a solid rod of material. However, a relatively large amount of scrap material may be generated using a screw machine process, which may increase a cost of fabricating the coaxial connector, for example. Moreover, screw machine processes may be relatively time consuming, which may limit a number of housings that can be fabricated within a given amount of time. The relatively time-consuming nature of fabricating a coaxial connector housing a screw machine process may increase the cost of fabricating a coaxial connector.

There is a need for a coaxial connector having a housing that can be fabricated using a reduced amount of raw material and/or that generates less scrap material during fabrication thereof. There is a need for a coaxial connector having a housing that can be fabricated in a reduced amount of time.

### BRIEF DESCRIPTION OF THE INVENTION

In one embodiment, a coaxial connector is provided for mating with a mating connector. The coaxial connector includes a dielectric insert, an inner electrical contact held by the dielectric insert, and a housing including a dielectric body and an electrically conductive sleeve mounted to the dielectric body. The electrically conductive sleeve includes a receptacle. The dielectric insert is held within the receptacle of the electrically conductive sleeve. The electrically conductive sleeve includes an outer electrical contact that extends around and is concentrically aligned with the inner electrical contact. The electrically conductive sleeve has a thread for threadably connecting the coaxial connector to the mating connector.

In another embodiment, a coaxial connector is provided for mating with a mating connector. The coaxial connector includes an inner electrical contact, and a housing including a dielectric body and a drawn sleeve that is drawn out of a material to include a cylindrical shape. The drawn sleeve is mounted to the dielectric body. The dielectric body includes an internal cavity. The inner electrical contact extends within the internal cavity. The drawn sleeve is electrically conductive and includes an outer electrical contact that extends around and is concentrically aligned with the inner electrical contact. The drawn sleeve has a thread for threadably connecting the coaxial connector to the mating connector.

In another embodiment, a housing is provided for a coaxial connector. The housing includes a dielectric body having an internal cavity, and a drawn sleeve that is drawn out of a material to include a cylindrical shape. The drawn sleeve is configured to be mounted to the dielectric body. The drawn sleeve is electrically conductive and includes an outer electrical contact having a thread for threadably connecting the coaxial connector to a mating connector.

### BRIEF DESCRIPTION OF THE DRAWINGS

FIG. 1 is a cross-sectional view illustrating an exemplary embodiment of a coaxial connector system.

FIG. 2 is a cross-sectional view of an exemplary embodiment of a housing of a coaxial connector of the system shown in FIG. 1.

FIG. 3 is an end elevational view of an exemplary embodiment of a sleeve of the housing shown in FIG. 2.

FIG. 4 is a cross-sectional view of the sleeve shown in FIG. 3 taken along line 4-4 of FIG. 3.

FIG. 5 is a cross-sectional view of an exemplary embodiment of the coaxial connector having the housing shown in FIG. 2.

FIG. 6 is a cross-sectional view of an exemplary embodiment of a housing of another coaxial connector of the system shown in FIG. 1.

FIG. 7 is an end elevational view of an exemplary embodiment of a sleeve of the housing shown in FIG. 6.

FIG. 8 is a cross-sectional view of the sleeve shown in FIG. 7 taken along line 8-8 of FIG. 7.

FIG. 9 is a cross-sectional view of an exemplary embodiment of the coaxial connector having the housing shown in FIG. 6.

### DETAILED DESCRIPTION OF THE INVENTION

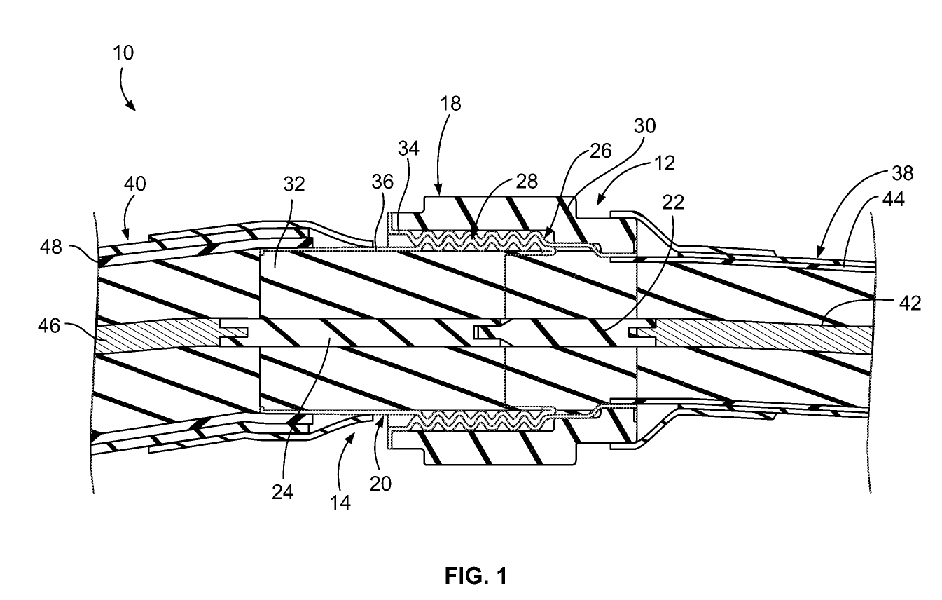

FIG. 1 is a cross-sectional view illustrating an exemplary embodiment of a coaxial connector system 10. The system 10 includes a coaxial connector 12 and a coaxial connector 14. The connectors 12 and 14 are complementary and mate together. Mating of the connectors 12 and 14 includes threadably connecting the connectors 12 and 14 together. The connectors 12 and 14 include respective housings 18 and 20. Inner electrical contacts 22 and 24 are held by the housings 18 and 20, respectively. The housings 18 and 20 include respective outer electrical contacts 26 and 28. When mated together as shown in FIG. 1, the inner electrical contacts 22 and 24 are engaged with each other and the outer electrical contacts 26 and 28 are engaged with each other to establish an electrical connection between the connectors 12 and 14. As will be described in more detail below, the housings 18 and 20 include respective dielectric bodies 30 and 32 and respective sleeves 34 and 36 that are mounted to the dielectric bodies 30 and 32, respectively. Each of the coaxial connectors 12 and 14 may be referred to herein as a “mating connector”. Each of the sleeves 34 and 36 may be referred to herein as an “electrically conductive sleeve” and/or a “drawn sleeve”.

In the exemplary embodiment, the connectors 12 and 14 are shown as terminating respective coaxial cables 38 and 40. More specifically, the inner and outer electrical contacts 22 and 26, respectively, of the coaxial connector 12 engage and are thereby electrically connected to respective inner and outer electrical conductors 42 and 44 of the coaxial cable 38, and the inner and outer electrical contacts 24 and 28, respectively, of the coaxial connector 14 engage and thereby electrically connect to respective inner and outer electrical conductors 46 and 48 of the coaxial cable 40. Alternatively, the coaxial connector 12 and/or the coaxial connector 14 may terminate and/or be mounted to any other type of electrical component, such as, but not limited to, a circuit board (not shown) and/or the like. Moreover, the coaxial connectors 12 and/or 14 may be electrically connected to any type of electrical component via the respective coaxial cable 38 and 40.

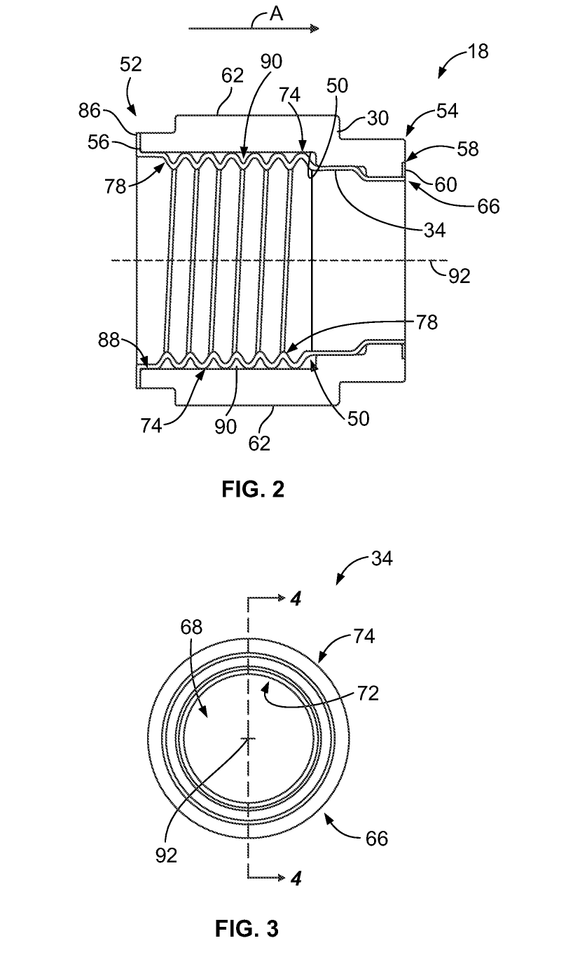

FIG. 2 is a cross-sectional view of an exemplary embodiment of the housing 18 of the coaxial connector 12. The housing 18 includes the dielectric body 30 and the sleeve 34. Relative to the dielectric body 30, the sleeve 34 is a discrete component of the housing 18 that is mounted to the dielectric body 30. The dielectric body 30 includes an internal compartment 50. The sleeve 34 is mounted to the dielectric body 30 such that the sleeve 34 is held within the internal compartment 50 of the dielectric body 30. The internal compartment 50 of the dielectric body 30 may be referred to herein as an “internal cavity”.

The dielectric body 30 extends a length from an end 52 to an opposite end 54. Optionally, the end 52 includes a stop shoulder 56 that engages the sleeve 34 to facilitate holding the sleeve 34 mounted to the dielectric body 30, as will be described below. The dielectric body 30 optionally includes one or more lock mechanisms 58 that facilitates holding the sleeve 34 mounted to the dielectric body 30. In the exemplary embodiment, the lock mechanism 58 includes a resiliently deflectable snap finger 60 that engages the sleeve 34 with a snap-fit connection to facilitate holding the sleeve 34 mounted to the dielectric body 30. But, the lock mechanism 58 may additionally or alternatively include any other method, structure, means, connection type, and/or the like, such as, but not limited to, a latch, using a press-fit (interference-fit) connection between the dielectric body 30 and the sleeve 34, and/or the like. Although shown at the end 54, the lock mechanism 58 may additionally or alternatively include any other location on the dielectric body 30. Optionally, the dielectric body 30 includes one or more flats 62 to facilitate rotation of the coaxial connector 12 relative to the coaxial connector 14 as the connectors 12 and 14 are threadably connected together.

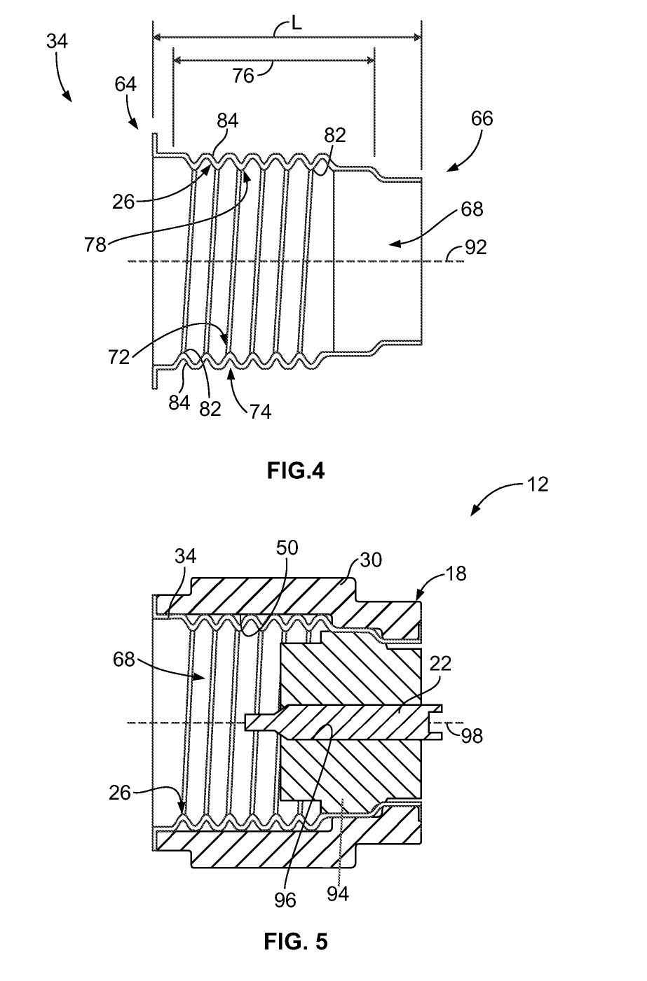

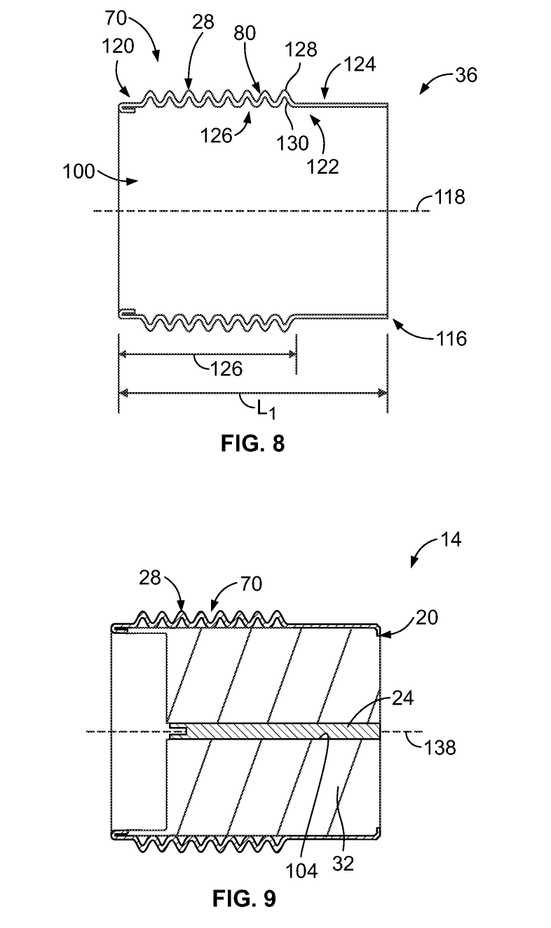

FIG. 3 is an end elevational view of an exemplary embodiment of the sleeve 34. FIG. 4 is a cross-sectional view of the sleeve 34 taken along line 4-4 of FIG. 3. Referring now to FIGS. 3 and 4, the sleeve 34 is electrically conductive. The sleeve 34 extends a length L (not shown in FIG. 3) along a central longitudinal axis 92 from an end 64 (not visible in FIG. 3) to an opposite end 66. As should be apparent from FIGS. 3 and 4, the sleeve 34 has a cylindrical shape along the length L thereof. The sleeve 34 has a receptacle 68 that, in the exemplary embodiment, extends through the length L of the sleeve 34. In the exemplary embodiment, the receptacle 68 is configured to receive a plug 70 (FIGS. 8 and 9) of the coaxial connector 14 (FIGS. 1 and 9) therein through the end 64 of the sleeve 34. The sleeve 34 includes opposite interior and exterior sides 72 and 74, respectively. The interior side 72 defines a boundary of the receptacle 68. The receptacle 68 may be referred to herein as an “internal compartment”. The interior side 72 of the sleeve 34 may be referred to herein as a “first side”. The exterior side 74 of the sleeve 34 may be referred to herein as a “second side”.

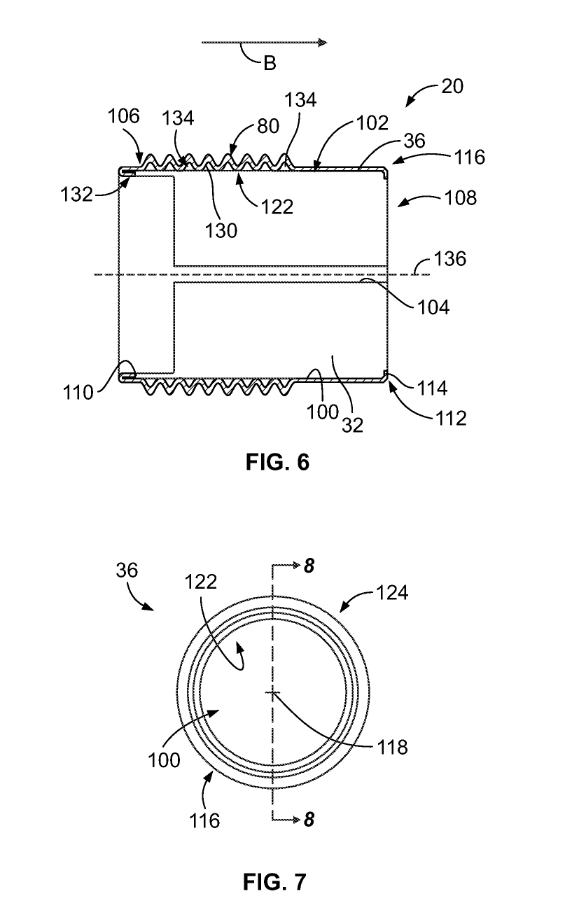

Referring now solely to FIG. 4, the length L of the sleeve 34 includes a segment 76 that defines the outer electrical contact 26 of the coaxial connector 12. The sleeve 34 includes a thread 78 for threadably connecting the coaxial connector 12 to the coaxial connector 14 (FIGS. 1 and 9). Optionally, the segment 76 includes the thread 78 and the thread 78 defines the outer electrical contact 26. More specifically, in the exemplary embodiment, the outer electrical contact 26 of the coaxial connector 12 engages the outer electrical contact 28 (FIGS. 1, 8, and 9) of the coaxial connector 14 at the thread 78. The thread 78 extends on the interior side 72 of the sleeve 34 for threadably connecting to an exterior thread 80 (FIGS. 6 and 8) of the coaxial connector 14. The thread 78 is defined by a protrusion 82 on the interior side 72 of the sleeve 34. The protrusion 82 extends along a spiral path on the interior side 72 and is configured to threadably connect to the thread 80 of the coaxial connector 14. Optionally, the protrusion 82 is defined by a groove 84 on the exterior side 74 of the sleeve 34. The portion of the interior side 72 that includes the protrusion 82 may be referred to herein as a “connection side” of the thread 78. The thread 78 threadably connects to the coaxial connector 14 at the connection side 72 of the thread 78. The portion of the exterior side 74 that includes the groove 84 may be referred to herein as a “back side” of the thread 78.

The sleeve 34 may be fabricated from any material(s) that enable the sleeve 34 to provide an electrical path between the outer electrical contact 28 of the coaxial connector 14 and the outer electrical conductor 44 (FIG. 1) of the coaxial cable 38 (FIG. 1). The sleeve 34 may be fabricated using any method, process, structure, means, and/or the like, such as, but not limited to, using a cutting process, using a casting process, using a molding process, using a forming process, and/or the like. Cutting processes include, but are not limited to, water cutting, stamping, laser cutting, punching, cutting using a saw, drill bit, plane, mill, and/or other solid cutting tool, and/or the like. Forming processes include, but are not limited to, drawing, bending, and/or the like. When the sleeve 34 is fabricated using a cutting process, the sleeve 34 may be cut from a reel of material, from a blank of material, from an approximately flat sheet of material, from an approximately flat material, from a rod, and/or the like. In some embodiments, the sleeve 34 is a cut and formed sleeve that is cut from a material and then formed to include the cylindrical shape of the sleeve 34. The sleeve 34 is a cut and drawn sleeve that is cut from a material and then drawn to include the cylindrical shape of the sleeve 34 in some embodiments. Another example of the sleeve 34 is a stamped and formed sleeve that is stamped from a material and then formed to include the cylindrical shape of the sleeve 34. In some embodiments, the sleeve 34 is a cut and formed sleeve that is cut from an approximately flat material and formed to include the cylindrical shape of the sleeve 34. Moreover, in some embodiments, the sleeve 34 is a cut and drawn sleeve that is cut from an approximately flat material and drawn to include the cylindrical shape of the sleeve 34. Yet another example of the sleeve 34 is a stamped and drawn sleeve that is stamped from a material and then drawn to include the cylindrical shape of the sleeve 34.

Referring again to FIG. 2, the sleeve 34 is shown mounted to the dielectric body 30. The sleeve 34 is held within the internal compartment 50 of the dielectric body 30. An optional flange 86 of the sleeve 34 is engaged with the stop shoulder 56 of the dielectric body 30 to facilitate preventing the sleeve 34 from moving relative to the dielectric body 30 in the direction of the arrow A. The lock mechanism 58 of the dielectric body 30 cooperates with the sleeve 34 to facilitate holding the sleeve 34 mounted on the dielectric body 30. More specifically, in the exemplary embodiment, the snap finger 60 of the lock mechanism 58 is engaged with the end 66 of the sleeve 34 with a snap-fit connection to facilitate holding the sleeve 34 mounted to the dielectric body 30. As described above, the sleeve 34 may be held as mounted to the dielectric body 30 using a press-fit (interference-fit) connection between the dielectric body 30 and the sleeve 34 in addition or alternatively to the lock mechanism 58 and/or the stop shoulder 56.

The dielectric body 30 supports the back side 74 of the thread 78. More specifically, an interior side 88 of the dielectric body 30 extends along and is engaged with the exterior side 74 of the sleeve 34 at the thread 78. The interior side 88 of the dielectric body 30 provides mechanical support to the back side 74 of the thread 78. As can be seen in FIG. 2, a gap 90 extends radially, relative to a central longitudinal axis 92 of the housing 18, between the back side 74 of the thread 78 and interior side 88 of the dielectric body 30. The gap 90 is defined by the groove 84.

FIG. 5 is a cross-sectional view of an exemplary embodiment of the coaxial connector 12. The coaxial connector 12 includes the housing 18, a dielectric insert 94, and the inner electrical contact 22. The dielectric insert 94 is held within the receptacle 68 of the sleeve 34 of the housing 18. The dielectric insert 94 extends within the internal compartment 50 of the dielectric body 30 of the housing 18. The inner electrical contact 22 extends within the internal compartment 50 of the dielectric body 30. More specifically, the inner electrical contact 22 of the coaxial connector 12 is held by the dielectric insert 94 within an internal cavity 96 of the dielectric insert 94. The outer electrical contact 26 of the coaxial connector 12 extends around the inner electrical contact 22. The outer and inner electrical contacts 26 and 22, respectively, are concentrically aligned about a central longitudinal axis 98 of the coaxial connector 12.

The exemplary embodiment of the inner electrical contact 22 is a pin. The pin is a male contact that is configured to be received within a female contact (e.g., the inner electrical contact 24 of the coaxial connector 14). However, the inner electrical contact 22 is alternatively a female contact that is configured to receive a male contact. Moreover, when provided as a male contact, the inner electrical contact 22 is not limited to the pin, but rather may have any other shaped, configured, and/or the like male contact.

FIG. 6 is a cross-sectional view of an exemplary embodiment of the housing 20 of the coaxial connector 14. The housing 20 includes the dielectric body 32 and the sleeve 36. Relative to the dielectric body 32, the sleeve 36 is a discrete component of the housing 20 that is mounted to the dielectric body 32. The sleeve 36 includes an internal compartment 100. The dielectric body 32 includes an exterior side 102 and an internal cavity 104. The sleeve 36 is mounted to the dielectric body 32 such that the sleeve 34 extends around the exterior side 102 of the dielectric body 32. In other words, the sleeve 34 is mounted to the dielectric body 32 such that the dielectric body 32 is held within the internal compartment 100 of the sleeve 36. The internal compartment 100 may be referred to herein as a “receptacle”.

The dielectric body 32 extends a length from an end 106 to an opposite end 108. Optionally, the end 106 includes a stop shoulder 110 that engages the sleeve 36 to facilitate holding the sleeve 36 mounted to the dielectric body 32. The sleeve 36 optionally includes one or more lock mechanisms 112 that facilitate holding the sleeve 36 mounted to the dielectric body 32. In the exemplary embodiment, the lock mechanism 112 includes a resiliently deflectable snap finger 114 that engages the end 108 of the dielectric body 32 with a snap-fit connection to facilitate holding the sleeve 36 mounted to the dielectric body 32. But, the lock mechanism 112 may additionally or alternatively include any other method, structure, means, connection type, and/or the like, such as, but not limited to, a latch, using a press-fit (interference-fit) connection between the dielectric body 32 and the sleeve 36, and/or the like. Although shown at an end 116 of the sleeve 36, the lock mechanism 112 may additionally or alternatively include any other location on the sleeve 36.

FIG. 7 is an end elevational view of an exemplary embodiment of the sleeve 36. FIG. 8 is a cross-sectional view of the sleeve 36 taken along line 8-8 of FIG. 7. Referring now to FIGS. 7 and 8, the sleeve 36 is electrically conductive. The sleeve 36 extends a length L₁ (not shown in FIG. 7) along a central longitudinal axis 118 from an end 120 (not visible in FIG. 7) to the opposite end 116. As should be apparent from FIGS. 7 and 8, the sleeve 36 has a cylindrical shape along the length L₁ thereof.

The sleeve 36 includes opposite interior and exterior sides 122 and 124, respectively. The interior side 122 defines a boundary of the internal compartment 100. The interior side 122 of the sleeve 34 may be referred to herein as a “second side”. The exterior side 124 may be referred to herein as a “first side”.

Referring now solely to FIG. 8, the length L_{I} of the sleeve 36 includes a segment 126 that defines the outer electrical contact 28 of the coaxial connector 14. The sleeve 36 includes the thread 80 for threadably connecting the coaxial connector 14 to the coaxial connector 12 (FIGS. 1 and 5). Optionally, the segment 126 includes the thread 80 and the thread 80 defines the outer electrical contact 28. More specifically, in the exemplary embodiment, the outer electrical contact 28 of the coaxial connector 14 engages the outer electrical contact 26 (FIGS. 1, 4, and 5) of the coaxial connector 12 at the thread 80. In the exemplary embodiment, the outer electrical contact 28 of the coaxial connector 14 defines the plug 70 that is configured to be received within the receptacle 68 (FIGS. 3-5) of the coaxial connector 12.

The thread 80 extends on the exterior side 124 of the sleeve 36 for threadably connecting to the interior thread 78 (FIGS. 2 and 4) of the coaxial connector 12. The thread 80 is defined by a protrusion 128 on the exterior side 124 of the sleeve 36. The protrusion 128 extends along a spiral path on the exterior side 124 and is configured to threadably connect to the thread 78 of the coaxial connector 12. Optionally, the protrusion 128 is defined by a groove 130 on the interior side 122 of the sleeve 36. The portion of the exterior side 124 that includes the protrusion 128 may be referred to herein as a “connection side” of the thread 80. The thread 80 threadably connects to the coaxial connector 12 at the connection side 124 of the thread 80. The portion of the interior side 122 that includes the groove 130 may be referred to herein as a “back side” of the thread 80.

The sleeve 36 may be fabricated from any material(s) that enable the sleeve 36 to provide an electrical path between the outer electrical contact 26 of the coaxial connector 12 and the outer electrical conductor 48 (FIG. 1) of the coaxial cable 40 (FIG. 1). The sleeve 36 may be fabricated using any method, process, structure, means, and/or the like, such as, but not limited to, using a cutting process, using a casting process, using a molding process, using a forming process, and/or the like. Cutting processes include, but are not limited to, water cutting, stamping, laser cutting, punching, cutting using a saw, drill bit, plane, mill, and/or other solid cutting tool, and/or the like. Forming processes include, but are not limited to, drawing, bending, and/or the like. When the sleeve 36 is fabricated using a cutting process, the sleeve 36 may be cut from a reel of material, from a blank of material, from an approximately flat sheet of material, from an approximately flat material, from a rod, and/or the like. In some embodiments, the sleeve 36 is a cut and formed sleeve that is cut from a material and then formed to include the cylindrical shape of the sleeve 36. The sleeve 36 is a cut and drawn sleeve that is cut from a material and then drawn to include the cylindrical shape of the sleeve 36 in some embodiments. Another example of the sleeve 36 is a stamped and formed sleeve that is stamped from a material and then formed to include the cylindrical shape of the sleeve 36. In some embodiments, the sleeve 36 is a cut and formed sleeve that is cut from an approximately flat material and formed to include the cylindrical shape of the sleeve 36. Moreover, in some embodiments, the sleeve 36 is a cut and drawn sleeve that is cut from an approximately flat material and drawn to include the cylindrical shape of the sleeve 36. Yet another example of the sleeve 36 is a stamped and drawn sleeve that is stamped from a material and then drawn to include the cylindrical shape of the sleeve 36.

Referring again to FIG. 6, the sleeve 36 is shown mounted to the dielectric body 32. An optional flange 132 of the sleeve 36 is engaged with the stop shoulder 110 of the dielectric body 32 to facilitate preventing the sleeve 36 from moving relative to the dielectric body 32 in the direction of the arrow B. The lock mechanism 112 of the sleeve 36 cooperates with the dielectric body 32 to facilitate holding the sleeve 36 mounted on the dielectric body 32. More specifically, in the exemplary embodiment, the snap finger 114 of the lock mechanism 112 is engaged with the end 108 of the dielectric body 32 with a snap-fit connection to facilitate holding the sleeve 36 mounted to the dielectric body 32. As described above, the sleeve 36 may be held as mounted to the dielectric body 32 using a press-fit (interference-fit) connection between the dielectric body 32 and the sleeve 36 in addition or alternatively to the lock mechanism 112 and/or the stop shoulder 110.

The dielectric body 32 supports the back side 122 of the thread 80. More specifically, the exterior side 102 of the dielectric body 32 extends along and is engaged with the interior side 122 of the sleeve 36 at the thread 80. The exterior side 102 of the dielectric body 32 provides mechanical support to the back side 122 of the thread 80. As can be seen in FIG. 6, a gap 134 extends radially, relative to a central longitudinal axis 136 of the housing 20, between the back side 122 of the thread 80 and exterior side 102 of the dielectric body 32. The gap 134 is defined by the groove 130.

FIG. 9 is a cross-sectional view of an exemplary embodiment of the coaxial connector 14. The coaxial connector 14 includes the housing 20 and the inner electrical contact 24. The inner electrical contact 24 is held by the dielectric body 32 such that the inner electrical contact 24 extends within the internal cavity 104 of the dielectric body 32. The outer electrical contact 28 of the coaxial connector 14 extends around the inner electrical contact 24 such that the outer and inner electrical contacts 28 and 24, respectively, are concentrically aligned about a central longitudinal axis 138 of the coaxial connector 14.

The exemplary embodiment of the inner electrical contact 24 is a receptacle contact. The receptacle contact is a female contact that is configured receive a male contact (e.g., the inner electrical contact 22 of the coaxial connector 12) therein. However, the inner electrical contact 24 is alternatively a male contact that is configured to be received by a female contact. Moreover, when provided as a female contact, the inner electrical contact 24 is not limited to the receptacle, but rather may have any other shaped, configured, and/or the like female contact.

The embodiments described and/or illustrated herein may be implemented in any type of coaxial connector for use interconnecting any type(s) of electrical components. Examples of coaxial connector types include, but are not limited to, N connectors, BNC connectors, TNC connectors, ETNC connectors, SMA connectors, SMB connectors, SMC connectors, F connectors, and/or the like.

The embodiments described and/or illustrated herein may provide a coaxial connector having a housing that can be fabricated using a reduced amount of raw material and/or that generates less scrap material during fabrication thereof. The embodiments described and/or illustrated herein may provide a coaxial connector having a housing that can be fabricated in a reduced amount of time and/or at a reduced cost.

Exemplary embodiments are described and/or illustrated herein in detail. The embodiments are not limited to the specific embodiments described herein, but rather, components and/or steps of each embodiment may be utilized independently and separately from other components and/or steps described herein. Each component, and/or each step of one embodiment, can also be used in combination with other components and/or steps of other embodiments. When introducing elements/components/etc. described and/or illustrated herein, the articles “a”, “an”, “the”, “said”, and “at least one” are intended to mean that there are one or more of the element(s)/component(s)/etc. The terms “comprising”, “including” and “having” are intended to be inclusive and mean that there may be additional element(s)/component(s)/etc. other than the listed element(s)/component(s)/etc. Moreover, the terms “first,” “second,” and “third,” etc. in the claims are used merely as labels, and are not intended to impose numerical requirements on their objects. Dimensions, types of materials, orientations of the various components, and the number and positions of the various components described and/or illustrated herein are intended to define parameters of certain embodiments, and are by no means limiting and are merely exemplary embodiments. Many other embodiments and modifications within the spirit and scope of the claims will be apparent to those of skill in the art upon reviewing the description and illustrations. The scope of the subject matter described and/or illustrated herein should therefore be determined with reference to the appended claims, along with the full scope of equivalents to which such claims are entitled. Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure.

While the subject matter described and/or illustrated herein has been described in terms of various specific embodiments, those skilled in the art will recognize that the subject matter described and/or illustrated herein can be practiced with modification within the spirit and scope of the claims.

1. A coaxial connector for terminating a coaxial cable and mating with a mating connector, the coaxial connector comprising:
a dielectric insert;
an inner electrical contact held by the dielectric insert, the inner electrical contact being configured to be electrically connected to an inner electrical conductor of the coaxial cable; and
a housing comprising a dielectric body and an electrically conductive sleeve mounted to the dielectric body, the electrically conductive sleeve comprising a receptacle, the dielectric insert being held within the receptacle of the electrically conductive sleeve, the electrically conductive sleeve comprising an outer electrical contact that extends around and is concentrically aligned with the inner electrical contact, the electrically conductive sleeve being configured to be engaged in physical contact with an outer electrical conductor of the coaxial cable such that the outer electrical contact is electrically connected to the outer electrical conductor, the electrically conductive sleeve having a thread for threadably connecting the coaxial connector to the mating connector.

2. The coaxial connector of claim 1, wherein the dielectric body comprises an internal compartment, the electrically conductive sleeve being mounted to the dielectric body such that the electrically conductive sleeve is held within the internal compartment of the dielectric body.

3. The coaxial connector of claim 1, wherein the electrically conductive sleeve is a drawn sleeve that is drawn out of a material into a cylindrical shape.

4. The coaxial connector of claim 1, wherein the electrically conductive sleeve has opposite first and second sides, the thread having a protrusion on the first side that is configured to threadably connect with the mating connector, the protrusion being defined by a groove extending on the second side of the electrically conductive sleeve.

5. The coaxial connector of claim 1, wherein the thread of the electrically conductive sleeve comprises a connection side and an opposite back side, the thread being configured to threadably connect with the mating connector at the connection side, the coaxial connector further comprising a gap extending radially between the back side of the thread and the dielectric body.

6. The coaxial connector of claim 1, wherein the dielectric body comprises a lock mechanism that cooperates with the electrically conductive sleeve to mount the electrically conductive sleeve to the dielectric body.

7. The coaxial connector of claim 1, wherein the thread extends on an interior side of the electrically conductive sleeve for threadably connecting to an exterior thread of the mating connector.

8. A coaxial connector for mating with a mating connector, the coaxial connector comprising:
an inner electrical contact; and
a housing comprising a dielectric body and a drawn sleeve that is drawn out of a material to include a cylindrical shape, the drawn sleeve being mounted to the dielectric body, the dielectric body comprising an internal cavity, the inner electrical contact extending within the internal cavity, the drawn sleeve being electrically conductive and including an outer electrical contact that extends around and is concentrically aligned with the inner electrical contact, the drawn sleeve having a thread for threadably connecting the coaxial connector to the mating connector.

9. The coaxial connector of claim 8, wherein the dielectric body comprises an exterior side, the drawn sleeve being mounted to the dielectric body such that the drawn sleeve extends around the exterior side of the dielectric body.

10. The coaxial connector of claim 8, wherein the drawn sleeve comprises an internal compartment, the drawn sleeve being mounted to the dielectric body such that the dielectric body is held within the internal compartment of the drawn sleeve.

11. The coaxial connector of claim 8, wherein the drawn sleeve is mounted to the dielectric body such that the drawn sleeve is held within the internal cavity of the dielectric body, the coaxial connector further comprising a dielectric insert that is held within a receptacle of the drawn sleeve, the inner electrical contact being held by the dielectric insert.

12. The coaxial connector of claim 8, wherein the drawn sleeve has opposite first and second sides, the thread having a protrusion on the first side that is configured to threadably connect with the mating connector, the protrusion being defined by a groove extending on the second side of the drawn sleeve.

13. The coaxial connector of claim 8, wherein the thread of the drawn sleeve comprises a connection side and an opposite back side, the thread being configured to threadably connect with the mating connector at the connection side, the coaxial connector further comprising a gap extending radially between the back side of the thread and the dielectric body.

14. The coaxial connector of claim 8, wherein the thread extends on an exterior side of the drawn sleeve for threadably connecting to an interior thread of the mating connector.

15. The coaxial connector of claim 8, wherein the thread extends on an interior side of the drawn sleeve for threadably connecting to an exterior thread of the mating connector.

16. The coaxial connector of claim 8, wherein the drawn sleeve is a cut and drawn sleeve that is cut from an approximately flat material and then drawn to include the cylindrical shape.

17. The coaxial connector of claim 8, wherein the dielectric body comprises a lock mechanism that cooperates with the drawn sleeve to mount the drawn to the dielectric body.

18. A housing for a coaxial connector, the housing comprising:
a dielectric body having an internal cavity; and
a drawn sleeve that is drawn out of a material to include a cylindrical shape, the drawn sleeve being configured to be mounted to the dielectric body, the drawn sleeve being electrically conductive and including an outer electrical contact, the outer electrical contact having a thread for threadably connecting the coaxial connector to a mating connector.

19. The housing of claim 18, wherein the dielectric body comprises an exterior side, the drawn sleeve being configured to be mounted to the dielectric body such that the drawn sleeve extends around the exterior side of the dielectric body.

20. The housing of claim 18, wherein the drawn sleeve is configured to be mounted to the dielectric body such that the drawn sleeve is held within the internal cavity of the dielectric body, the housing further comprising a dielectric insert that is held within a receptacle of the drawn sleeve.

21. The coaxial connector of claim 1, further comprising the coaxial cable, the electrically conductive sleeve being engaged in physical contact with the outer electrical conductor of the coaxial cable.
